(19) United States
(12) Patent Application Publication
(10) Pub. No.: US 2006/0238595 A1
(43) Pub. Date: Oct. 26, 2006

(54) Shingling printing method and inkjet image forming apparatus using the same

(76) Inventor: Jin-ho Park, Yongin-si (KR)

Correspondence Address: STANZIONE & KIM, LLP, 919 18TH STREET, N.W., SUITE 440, WASHINGTON, DC, 20006, US

(21) Appl. No.: 11/288,325

(22) Filed: Nov. 29, 2005

(30) Foreign Application Priority Data
Apr. 20, 2005 (KR) 2005-32770

(51) Int. Cl. B41J 2/01; B41J 11/42

(52) U.S. Cl. 347/104

(57) ABSTRACT

A shingling printing method and an inkjet image forming apparatus. The shingling printing method includes feeding the paper in a forward direction and performing a printing operation, feeding the paper in a reverse direction, moving the inkjet head in a main scanning direction, and repeatedly performing each of the operations of feeding the paper in the forward direction and the performing the printing operation, feeding the paper in the reverse direction, and moving the inkjet head in the main scanning direction ‘n’ times and performing a final printing operation. The inkjet image forming apparatus includes an inkjet head having nozzles arranged along a main scanning direction to print an image by ejecting ink onto a recording medium and installed to make a reciprocating motion in the main scanning direction, a recording medium feeding unit having a feeding roller and a recording medium discharging roller to feed and discharge the recording medium, a head moving unit to move the inkjet head in the main scanning direction, and a controller to control the recording medium feeding unit so that the recording medium is fed in the forward direction and then in the reverse direction, and to control the head moving unit so that the inkjet head is moved in the main scanning direction when the recording medium is moved in the reverse direction.

### CROSS-REFERENCE TO RELATED APPLICATIONS

This application claims the benefit under 35 U.S.C. § 119 of Korean Patent Application No. 2005-32770, filed on Apr. 20, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to a line printing inkjet image forming apparatus with an inkjet head having a nozzle unit corresponding to a paper (or other recording medium) width, which can perform printing using a printing shingling method.

2. Description of the Related Art

In general, an image forming apparatus forms an image by ejecting ink from an inkjet head that is spaced apart from a top side of paper by a predetermined gap. The inkjet head makes a reciprocating motion in a direction perpendicular to a paper feeding direction. The image forming apparatus that prints the image by ejecting the ink onto the paper while the inkjet head moves in the direction perpendicular to the paper feeding direction is referred to as a shuttle-type inkjet image forming apparatus. A nozzle unit having a plurality of nozzles for ejecting ink is disposed in the inkjet head of the shuttle-type inkjet image forming apparatus.

In order to perform a printing operation at a high speed, a wide array inkjet head having a nozzle unit with a length corresponding to a paper width has been used. An image forming apparatus including the wide array inkjet head is referred to as a line printing inkjet image forming apparatus. In the line printing inkjet image forming apparatus, the wide array inkjet head is fixed and only the paper moves. Thus, a driving device for the line printing inkjet image forming apparatus is simple and the printing operation can be performed at the high speed.

However, in the line printing inkjet image forming apparatus, when a part of the nozzle unit is damaged and the nozzle unit cannot eject ink from the damaged part, the printing operation is defective because the damaged nozzle unit part can not eject ink to a corresponding portion of the paper. Thus, printing defects, such as a white line and the like, occur when the nozzle unit is damaged. In order to prevent printing defects in the shuttle-type inkjet image forming apparatus, the shuttle-type inkjet image forming apparatus performs a printing operation using a shingling printing method. The shingling printing method is a technique in which the printing operation is repeated and overlaps while moving a printing position finely by changing a position of the print head.

However, conventionally, when using the line printing inkjet image forming apparatus, the ink is ejected in a paper proceeding direction only once. Due to structural characteristics, the line printing inkjet image forming apparatus can not easily perform the printing operation using the shingling method so as to correct the above described printing defects. In addition, in the line printing inkjet printing apparatus, a printing resolution is determined by a physical distance between nozzles. However, since the wide array inkjet head is fixed, the printing operation can not be performed to have with a higher resolution than an actual resolution.

### SUMMARY OF THE INVENTION

The present general inventive concept provides a line printing inkjet image forming apparatus which prints overlapping images using a shingling method to achieve a resolution that is higher than a nominal resolution or to compensate for a damaged part of a nozzle that cannot eject ink

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a shingling method performed in an inkjet image forming apparatus comprising an inkjet head having nozzles arranged along a main scanning direction to print an image by ejecting ink onto a paper, a feeding roller and a paper discharging roller to feed and discharge the paper, the method including feeding the paper in a forward direction and performing a printing operation, feeding the paper in a reverse direction, moving the inkjet head in a main scanning direction perpendicular to the forward direction, and repeatedly performing each of the operations of feeding the paper in the forward direction and performing a printing operation, feeding the paper in the reverse direction, and moving the inkjet head in the main scanning direction n times and performing a final printing operation.

The feeding of the paper in the reverse direction may be performed so that a feeding distance in the reverse direction is less than or equal to a distance between a front-end nozzle that is closest to the feeding roller and the feeding roller. The operations of feeding the paper in the forward direction and feeding the paper in the reverse direction may be performed so that feeding distance in the reverse direction may be less than a feeding distance in the forward direction.

The moving of the inkjet head in the main scanning direction may be moved in a stepwise manner by a distance obtained by equally dividing a physical distance between the nozzles in a horizontal direction.

The moving of the inkjet head in the main scanning direction may be performed in a stepwise manner by a distance obtained by adding a first distance obtained by multiplying a physical distance between the nozzles by an integral multiple, to a second distance obtained by equally dividing the physical distance between the nozzles.

When an actual resolution of the nozzle unit is l and a resolution at which to print the image on the paper is m, the moving of the inkjet head in the main scanning direction may be performed in a stepwise manner by a distance obtained by equally dividing the physical distance between the nozzles in the horizontal direction by m/l.

The nozzles may be arranged along the main scanning direction in an array longer than a width of the paper.

The foregoing and/or other aspects of the present general inventive concept are also achieved by providing a shingling method performed in an inkjet image forming apparatus comprising an inkjet head having nozzles arranged along a main scanning direction to print an image by ejecting ink onto a paper, a feeding roller and a paper discharging roller to feed and discharge the paper, the method including feeding the paper in a forward direction and performing a printing operation, moving the inkjet head in a main scanning direction perpendicular to the forward direction, feeding the paper in a reverse direction opposite to the forward direction, and repeatedly performing each of the operations of feeding the paper in the forward direction and performing a printing operation, moving the inkjet head in the main scanning direction, and feeding the paper in the reverse direction n times and performing a final printing operation.

The feeding of the paper in the reverse direction may be performed so that a feeding distance in the reverse direction is less than or equal to a distance between a front-end nozzle that is closest to the feeding roller and the feeding roller. The feeding of the paper in the forward direction and feeding of the paper in the reverse direction may be performed such that the feeding distance in the reverse direction may be less than a feeding distance in the forward direction.

The moving of the inkjet head may be performed in a stepwise manner by a distance obtained by equally dividing a physical distance between nozzles in a horizontal direction.

The moving of the inkjet head may be performed in a stepwise manner by a distance obtained by adding a first distance obtained by multiplying a physical distance between the nozzles by an integral multiple, to a second distance obtained by equally dividing the physical distance between the nozzles.

When an actual resolution of the nozzle unit is l and a resolution at which the printing operation is to be performed is m, the moving of the inkjet head may be performed in a stepwise manner by a distance obtained by equally dividing the physical distance between the nozzles in the horizontal direction by m/l.

The nozzles may be arranged along the main scanning direction in an array longer than a width of the paper.

The foregoing and/or other aspects of the present general inventive concept are also achieved by providing an inkjet image forming apparatus, the inkjet image forming apparatus including an inkjet head having nozzles arranged along a main scanning direction to print an image by ejecting ink onto paper and installed to make a reciprocating motion in the main scanning direction, a paper feeding unit having a feeding roller and a paper discharging roller to feed the paper in a forward or reverse direction, a head moving unit to move the inkjet head in the main scanning direction, and a controller to control the paper feeding unit so that the paper is fed in the forward direction during a printing operation and then the paper is moved in the reverse direction after the printing operation, and to control the head moving unit so that the inkjet head is moved in the main scanning direction when the paper is fed in the reverse direction.

The controller may control the operation of the paper feeding unit to repeatedly feed the paper in the reverse direction and in the forward direction n times and to control the inkjet head to print the image on the paper when the paper if fed in forward direction. The controller may control the paper feeding unit to feed the paper in the reverse direction so that a feeding distance in the reverse direction is less than or equal to a distance between a front-end nozzle that is closest to the feeding roller and the feeding roller. The controller may control the paper feeding unit to feed the paper in the reverse direction so that the feeding distance in the reverse direction is less than a feeding distance in the forward direction.

The controller may control the head moving unit to move the inkjet head in a stepwise manner by a distance obtained by equally dividing a physical distance between nozzles in a horizontal direction.

The controller may control the head moving unit to move the inkjet head in a stepwise manner by a distance obtained by adding a first distance obtained by multiplying a physical distance between the nozzles by an integral multiple, to a second distance obtained by equally dividing the physical distance between the nozzles.

When an actual resolution of the nozzle unit is l and a resolution at which to print the image on the paper is m, the controller may control the head moving unit to move the inkjet head in a stepwise manner by the distance obtained by equally dividing a physical distance between the nozzles in the horizontal direction by m/l.

The head moving unit may include an adjusting portion to move the inkjet head in the main scanning direction in a stepwise manner, and a bias portion to bias the inkjet head moved by the adjusting portion toward an original position thereof.

The adjusting portion may include an eccentric cam rotatably installed on a main body frame to move the inkjet head, and a driving source to rotate the eccentric cam.

The bias portion may include an elastic member installed between a main body frame and the inkjet head to elastically bias the inkjet head toward the original position thereof.

The nozzles may be arranged along an array longer than a width of the paper.

The foregoing and/or other aspects of the present general inventive concept are also achieved by providing a printing method performed in an inkjet image forming apparatus including an inkjet head having nozzles arranged along a main scanning direction corresponding to a width of a recording medium fed in a feeding direction that is perpendicular to the main scanning direction, the method comprising performing at least one cycle including moving the recording medium in a forward direction by a first distance under the inkjet head that ejects ink onto the recording medium, moving the recording medium by a second distance that is less than or equal to the first distance in a reverse direction, and shifting an inkjet head position in a transverse direction perpendicular to the forward direction.

The foregoing and/or other aspects of the present general inventive concept are also achieved by providing an inkjet image forming apparatus to print an image o a recording medium that moves along a recording medium path, the apparatus comprising a feeding module to pickup the recording medium from a recording medium storage unit, to move the recording medium along the recording medium path and to discharge the recording medium in a stacking unit, a printing unit disposed above the recording medium path to eject ink onto the recording medium corresponding to the image, and a control unit to control the feeding module to move the recording medium repeatedly in a forward direction and in a reverse direction under the printing unit, and to shift the position of the printing unit in a direction perpendicular to the recording medium path when the recording medium is moved in the reverse direction.

The foregoing and/or other aspects of the present general inventive concept are also achieved by providing an image forming apparatus comprising a wide array type inkjet head having a plurality of nozzles defining a first resolution, and the wide array type inkjet head being movable laterally, a feeding unit to move a recording medium forward and backward with respect to the wide array type inkjet head, and a control unit to control the wide array type inkjet head to print an image having a second resolution, which is greater than the first resolution, by moving the wide array type inkjet head laterally by a predetermined distance, and to control the feeding unit to move the recording medium forward and backward such that the wide array type inkjet head performs a predetermined number of printing operations.

The foregoing and/or other aspects of the present general inventive concept are also achieved by providing a shingling printing method usable in an image forming apparatus, the method comprising performing a first printing operation on a recording medium using an inkjet head having a length corresponding to a width of the recording medium, moving the inkjet print head laterally with respect to the recording medium, and performing a second print operation on the recording medium using the inkjet head.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a cross-sectional view of an inkjet image forming apparatus according to an embodiment of the present general inventive concept;

FIG. 2 illustrates an inkjet head and a feeding unit included in the inkjet image forming apparatus illustrated in FIG. 1 according to an embodiment of the present general inventive concept;

FIG. 3 illustrates a nozzle unit of the inkjet head illustrated in FIG. 2 according to an embodiment of the present general inventive concept;

FIG. 4 illustrates an inkjet image forming apparatus which prints using a shingling printing method according to an embodiment of the present general inventive concept;

FIG. 5 is a view illustrating an eccentric cam included in the inkjet image forming apparatus illustrated in FIG. 4 according to an embodiment of the present general inventive concept;

FIG. 6 illustrates a shingling printing method according to an embodiment of the present general inventive concept;

FIG. 7 illustrates an operation of printing an image when the shingling printing method illustrated in FIG. 6 is performed according to an embodiment of the present general inventive concept;

FIG. 8 illustrates a shingling printing method according to another embodiment of the present general inventive concept; and

FIG. 9 is a flowchart illustrating an algorithm for the shingling printing method according to the embodiments illustrated in FIG. 6 or 8.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. An inkjet image forming apparatus with a line printing inkjet head (i.e., a wide array inkjet head) having a nozzle unit corresponding to a paper width will be first described and then shingling printing methods according to various embodiments of the present general inventive concept will be described.

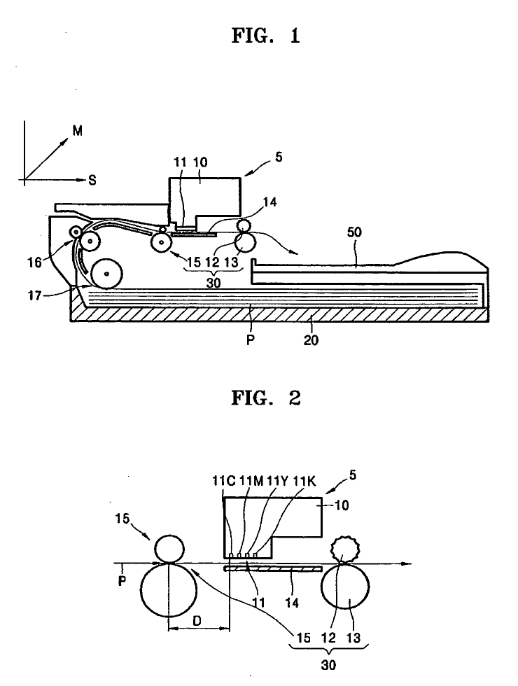

FIG. 1 is a cross-sectional view of an inkjet image forming apparatus according to an embodiment of the present general inventive concept. FIG. 2 illustrates an inkjet head and a paper feeding unit included in the inkjet image printing apparatus illustrated in FIG. 1.

Referring to FIG. 1, the inkjet image forming apparatus includes a paper feeding cassette 20, a pickup roller 17, an inkjet head 5, a support member 14 that faces the inkjet head 5, a paper feeding unit 30 that feeds a paper P in a subsidiary scanning direction S, and a stacking unit 50 on which discharged paper P is stacked. In addition, the paper feeding unit 30 includes a feeding roller 15 and paper discharging rollers 12 and 13 and feeds the paper P along a predetermined path. Here, a main scanning direction M is a direction along a width of the paper P as the paper P is fed through the paper feeding unit 30, and the subsidiary scanning direction S is a feeding direction of the paper P.

The paper P is initially stacked in the paper feeding cassette 20 and is then fed in the subsidiary scanning direction S using the pickup roller 17 and the paper feeding unit 30. The pickup roller 17 is installed at one side of the paper feeding cassette 20 and feeds the paper P stacked in the paper feeding cassette 20 to the feeding roller 15. The pickup roller 17 is rotated while pressing on a top of the stacked paper P, thereby feeding a first paper sheet (i.e. the paper P) from the stacked paper P outside of the paper feeding cassette 20.

Rollers 12, 13, and 15 of the paper feeding unit 30 can be rotated in a forward or a reverse direction by a driving source (not shown) such as a motor, and can feed the paper P in the forward direction, which is the subsidiary scanning direction S, or in the reverse direction. Here, the forward direction is a direction in which the paper P is picked up by the pickup roller 17 and fed to the inkjet head 5, and the reverse direction is a direction opposite to the forward direction.

The feeding roller 15 is installed at an inlet side of the inkjet head 5 to feed the paper P picked-up from the paper feeding cassette 20 to the inkjet head 5 or to feed the paper P in the reverse direction so as to print using the shingling printing method. In this case, the feeding roller 15 can align the paper P so that ink can be ejected onto a desired portion of the paper P, before the paper P is passed under the inkjet head 5. The feeding roller 15 can include a driving roller that provides a moving force to move (feed) the paper P and an idle roller elastically engaged with the driving roller. A pair of feeding rollers 16 that feeds the paper P can be further installed between the pickup roller 17 and the feeding roller 15.

The paper discharging rollers 12 and 13 are installed at an outlet side of the inkjet head 5 and discharge the paper P on which the printing operation has been completed outside the image forming apparatus, or feed the paper P in the reverse direction, so as to print using the shingling printing method. As illustrated in FIGS. 1 and 2, the paper discharging rollers 12 and 13 include a star wheel 12 installed in the main scanning direction M and a support roller 13 that faces the star wheel 12 and supports a rear side of the paper P. The paper P on a top side of which ink is ejected while passing under a nozzle unit 11 is wet by ink, and the paper P may wrinkle. If wrinkling is severe, the paper P may contact the nozzle unit 11 or a bottom surface of a body 10, and undried ink may be smeared on the paper P, so that an image printed thereon may be contaminated. In addition, a distance between the paper P and the nozzle unit 11 may be hard to maintain. The star wheel 12 prevents the paper P fed under the nozzle unit 11 from contacting the nozzle unit 11 or the bottom surface of the body 10 and maintains the distance between the paper P and the nozzle unit 11 at a constant. The star wheel 12 is installed to press the top side of paper P at a lower level than the nozzle unit 11. The star wheel 12 makes a point contact with the top side of the paper P so that an ink image that has been printed on the top side of the paper P and has not been dried yet, is not smeared or contaminated. A plurality of star wheels may be installed to feed the paper P smoothly. When the plurality of star wheels are installed parallel to each other to feed the paper P along the subsidiary scanning direction S, a plurality of support rollers that correspond to the star wheels may also be provided.

The support member 14 is disposed below the inkjet head 5 to maintain a predetermined distance between the nozzle unit 11 and the paper P, and to support the rear side of the paper P. The distance between the nozzle unit 11 and the paper P may be between 0.5-2.5 mm.

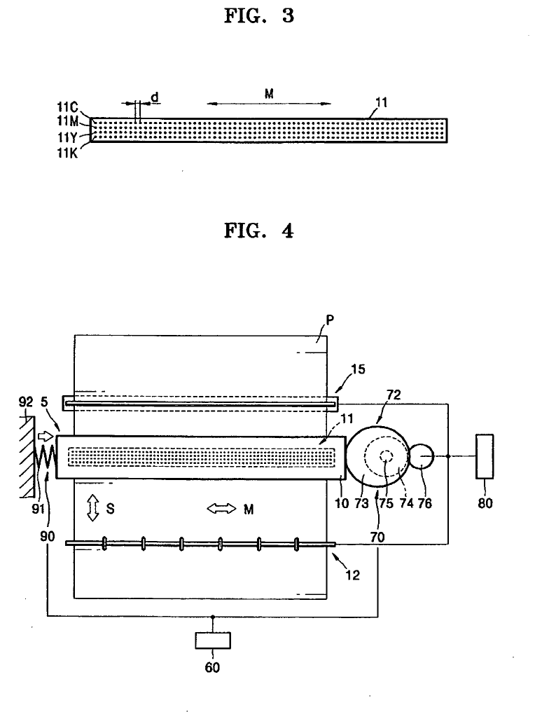

FIG. 3 illustrates the nozzle unit 11 of the inkjet head 5 illustrated in FIG. 2. Referring to FIGS. 2 and 3, the inkjet head 5 prints an image by ejecting ink onto the paper P using a plurality of nozzles 11C, 11M, 11Y, and 11K disposed along the main scanning direction M. The inkjet head 5 is installed to make a reciprocating motion in the main scanning direction M. In the present embodiment, the inkjet head 5 may be combined with a guide member (not shown) installed on a main body frame to be parallel to the nozzle unit 11 and can make the reciprocating motion in the main scanning direction M. The inkjet head 5 is a line printing inkjet head (i.e. a wide array inkjet head) that prints an image by ejecting ink in a fixed position using a nozzle unit having a length corresponding to a paper width. Although the present embodiment uses the line printing inkjet head (as opposed to the shuttle-type inkjet head), unlike conventional line printing inkjet heads, the inkjet head 5 is installed to be movable in the main scanning direction M to print according to the shingling printing method.

The inkjet head 5 includes the body 10 and the nozzle unit 11 disposed on a bottom part of the body 10. The feeding roller 15 is installed at an inlet side of the nozzle unit 11, and the star wheel 12 is rotatably installed at an outlet side of the nozzle unit 11. Referring to FIG. 3, the plurality of nozzles 11C, 11M, 11Y, and 11K that eject ink are arranged along the main scanning direction M. The nozzle unit 11 can include four nozzle arrays that eject ink of four colors such as cyan (C), magenta (M), yellow (Y), and black (K), for color printing. The plurality of nozzles 11C, 11M, 11Y, and 11K may form the four nozzle arrays to be longer than the width of the paper P Ink is stored in the body 10. In order to receive ink of four colors such as cyan (C), magenta (M), yellow (Y), and black (K), although not shown, the body 10 can be divided into four storage spaces. In addition, the body 10 may also be provided with a chamber (not shown) having an ejecting mechanism (for example, a piezo device or a heater) in communication with each of the nozzles of the nozzle unit 11 to provide pressure to eject the ink, and a passage to supply the ink from the body 10 to the chamber, etc. For illustration purposes, the nozzle unit 11 will be described by referring to the nozzles arranged in the order of cyan (C), magenta (M), yellow (Y), and black (K), as illustrated in FIG. 3. Although the nozzle unit 11 using a color inkjet method has been illustrated in the present embodiment, the nozzle unit 11 may be formed in a variety of shapes, and as illustrated in FIG. 3 It should be understood that a design of the nozzle unit 11 and a number and colors of the ink are not intended to be limited by these illustrations and embodiments.

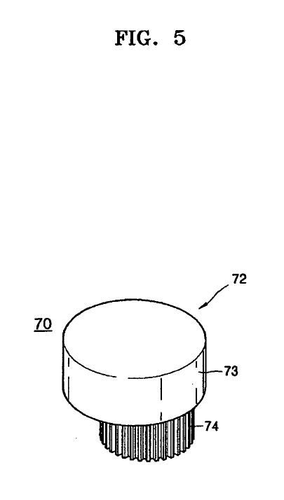

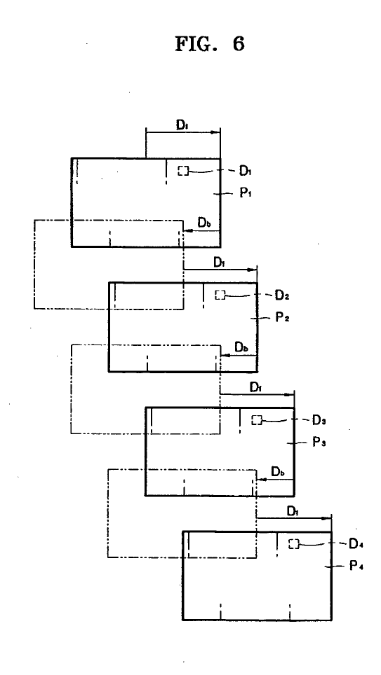

FIG. 4 illustrates a structure of an inkjet image forming apparatus which prints using a shingling printing method according to an embodiment of the present general inventive concept. FIG. 5 is a view illustrating an eccentric cam 72 included in the inkjet image forming apparatus illustrated in FIG. 4. Referring to FIGS. 4 and 5, a head moving unit 60 in contact with the inkjet head 5 moves the inkjet head 5 in the main scanning direction M. That is, the head moving unit 60 moves the inkjet head 5 in the main scanning direction M during a printing operation using the shingling printing method so as to improve printing resolution. The head moving unit 60 includes an adjusting portion 70 and a bias portion 90.

The adjusting portion 70 contacts the inkjet head 5 and moves the inkjet head 5 in the main scanning direction M in a stepwise manner. Referring to FIGS. 4 and 5, the adjusting portion 70 includes an eccentric cam 72 that is rotatably installed on a main body frame (not shown) and contacts the inkjet head 5, and a driving source 76 that rotates the eccentric cam 72. The eccentric cam 72 may include a rotating portion 74 rotatably inserted and installed into the main body frame (see FIG. 5), and a contacting portion 73 that contacts the inkjet head 5. The rotating portion 74 is inserted into a combining hole (not shown) formed in the main body frame and is rotatably installed around a reference point 75. The rotating portion 74 may be a gear member to which a rotative force is transmitted from the driving source 76. In addition, since the rotating portion 74 can contact the inkjet head 5 and move the inkjet head 5 in the main scanning direction M when rotating, the contacting portion 73 may be formed to be eccentric with respect to the rotating portion 74. Alternatively, the contacting portion 73 may be formed to have an elliptical shape instead of the shape illustrated in FIGS. 4 and 5. The driving source 76 provides a driving force needed to rotate the eccentric cam 72. The driving source 76 may be a piezoelectric device that is used in an apparatus requiring precise position control.

The bias portion 90 biases the inkjet head 5 that is movable by the adjusting portion 70 toward its original position. That is, the bias portion 90 applies an elastic pressure to the inkjet head 5 along the nozzle unit 11 towards the adjusting portion 70, during a printing operation using the shingling printing method. In the present embodiment, the bias portion 90 may include an elastic member 91 that is installed between a portion of the main body frame 92 and the inkjet head 5 and exerts the elastic pressure to bias the inkjet head 5 toward its original described position (i.e. toward the adjusting portion 70). The inkjet head 5 makes the reciprocating motion using the adjusting portion 70 and the bias portion 90.

Referring to FIG. 4, a controller 80 controls the paper feeding unit 30 and the head moving unit 60 so that the inkjet image forming apparatus can print using the shingling printing method. The shingling printing method according to the present embodiment is a method by which the inkjet head 5 is moved in small and precise steps (i.e. finely moved) to printing positions along the main scanning direction M. When using the shingling printing method, an image corresponding to one pixel is repeatedly overlapped and printed several times to form a high-quality image. In the present embodiment, the controller 80 controls the paper feeding unit 30 so that the paper P is fed in the forward direction and then in the reverse direction after the printing operation is performed in the forward direction and controls the head moving unit 60 so that the inkjet head 5 is repositioned in the main scanning direction M when the paper P is fed in the reverse direction. In the present embodiment, the controller 80 controls the paper feeding unit 30 to feed the paper P in the reverse direction an ‘n’ number of times and to print the image on the paper.

When the printing operation is performed using the shingling printing method, if a distance by which the paper P is fed in the reverse direction is larger than a distance by which the paper P is fed in the forward direction, an ink image that has been ejected onto the top side of the paper P and has not been dried can enter under the feeding roller 15 and can be contaminated. Thus, the controller 80 may control the paper feeding unit 30 to feed the paper P in the reverse direction so that a reverse feeding distance is less than or equal to a distance D (see FIG. 2) between a front-end nozzle 11C that is closest to the feeding roller 15 and the feeding roller 15.

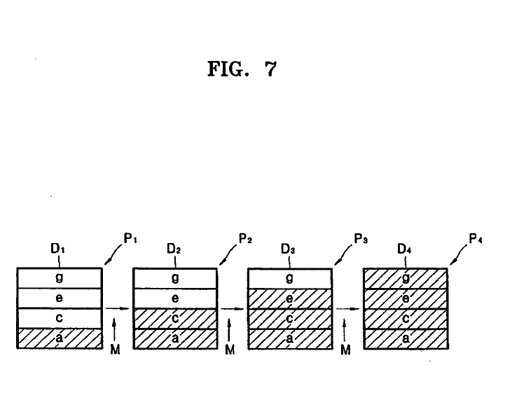

FIG. 6 illustrates the shingling printing method according to an embodiment of the present general inventive concept. As illustrated in FIG. 6, the controller 80 may control the paper feeding unit 30 to feed the paper P so that a distance D_{b} where the paper P is fed in the reverse direction is less than a distance D_{f} when the paper P is fed in the forward direction. Here, the reverse feeding distance D_{b} when the paper P is fed in the reverse direction should be less than or equal to a distance D (see FIG. 2) between the front-end nozzle 11C that is closest to the feeding roller 15 and the feeding roller 15.

Additionally, in order to print using the shingling printing method, the controller 80 may control the head moving unit 60 to move the inkjet head 5 by a distance that is equal to a physical distance ‘d’ (see FIG. 3) between nozzles along the main scanning direction M. The distance between the nozzles ‘d’ is a factor in determining a nominal printing resolution. A distance of moving the inkjet head 5 in the horizontal direction stepwise may be obtained by equally dividing the physical distance ‘d’ between the nozzles. That is, the controller 80 may control the head moving unit 60 to move the inkjet head 5 in the horizontal direction by the distance obtained by equally dividing the physical distance ‘d’ between the nozzles. The inkjet head 5 is moved whenever the paper P is fed in the reverse direction. However, since the distance obtained by equally dividing the physical distance ‘d’ between the nozzles may be very small, it is not easy to precisely move the inkjet head 5. Thus, the controller 80 may control the head moving unit 60 to move the inkjet head 5 stepwise by a distance obtained by adding to a distance obtained by equally dividing the physical distance ‘d’ between the nozzles a multiple of the physical distance ‘d’ between the nozzles. When the physical distance between the nozzles is ‘d’ and the number of times the paper P is fed in the reverse direction is ‘n’, the inkjet head 5 may be moved stepwise by a distance d/(n+1) whenever the paper P is fed in the reverse direction. Alternatively, the inkjet head 5 may be moved by the distance obtained by adding a distance, which is obtained by multiplying the physical distance ‘d’ between the nozzles by an integral multiple (that is, Nd, where N can be 1, 2, . . . ), to the distance obtained by equally dividing the physical distance ‘d’ between the nozzles.

In the present embodiment when an actual resolution of the nozzle unit 11 is ‘l’ and resolution at which the printing operation is to be performed is ‘m’, the controller 80 may control the head moving unit 60 to move the inkjet head 5 stepwise by a distance obtained by equally dividing the physical distance ‘d’ between the nozzles in the horizontal direction by m/l. Thus, the number ‘n’ should satisfy the condition n=m/l−1. In this case, the number ‘n’ may be controlled to satisfy D_{b}/D_{f}=n/(n+1).

For example, consider a case where the distance D between the front-end nozzle 11C and the feeding roller 15 is 30 mm and the resolution at which the printing operation is to be performed ‘m’ is 1200 dpi while the actual resolution ‘l’ of printing using the inkjet head 5 is 300 dpi. Here, since the distance D_{b}

in which the paper P is fed in the reverse direction should be less than or equal to the distance D between the front-end nozzle 11C and the feeding roller 15, it is assumed that D_{b}=D. Since the number ‘n’ satisfies n=m/l−1, in this case n=1200/300−1, n=3. In this case, the distance D_{f} in which the paper P is fed in the forward direction should satisfy D_{b}/D_{f}=n/(n+1), therefore the distance D_{f} is 40 mm. That is, in order to achieve the printing resolution ‘m’ of 1200 dpi using the inkjet head 5 having the actual resolution ‘l’ of 300 dpi, the paper P should be fed in the reverse direction at least three times when the printing operation is performed using the shingling printing method. That is, ink should be ejected onto the paper P four times so that resolution of 1200 dpi can be achieved.

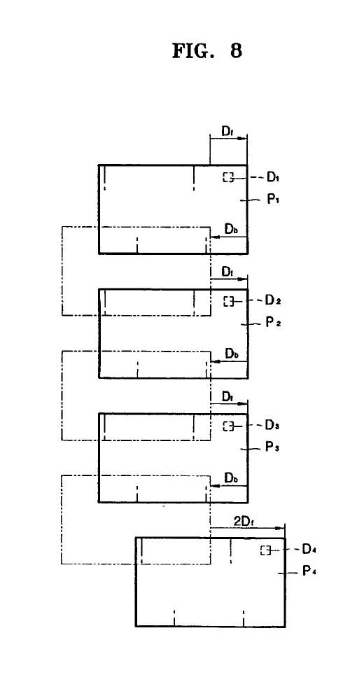

FIG. 7 illustrates an operation of printing an image when the shingling printing method illustrated in FIG. 6 is performed according to an embodiment of the present general inventive concept. The shingling printing method will now be described with reference to FIGS. 6 and 7. Reference numerals P₁, P₂, P₃, and P₄ are positions of the paper P after being fed in the forward direction and dashed frames represent positions of the paper P after being fed in the reverse direction. For illustration purposes, the positions of the paper P are disposed from up to down in FIG. 6 according to successive movements. However, it should be understood that the paper positions actually overlap along the subsidiary scanning direction S (feeding direction), and that the paper P has no movement in a direction perpendicular to the subsidiary scanning direction S (i.e. main scanning direction). D_{f} is the distance by which the paper P is fed in the forward direction, and D_{b} is the distance by which the paper P is fed in the reverse direction. D₁, D₂, D₃, and D₄, respectively, represent the same area (e.g. one pixel) traced in the positions P₁, P₂, P₃, and P₄ of the paper P. In FIG. 7, the operation of printing the image using the shingling printing method is illustrated by tracking a printing status in the one pixel area represented by D₁, D₂, D₃, and D₄.

Referring to FIGS. 6 and 7, during an initial printing operation, while the paper P is fed in the forward direction by an amount D_{f}, ink is ejected from the inkjet head 5 onto a region (a) corresponding to a resolution of 300 dpi so that a first image is formed. At this time, a printing status of the one pixel area is represented by D₁ on paper P₁. Then, the paper P₁ is fed in the reverse direction by an amount D_{b} using the paper feeding unit 30. In this case, the inkjet head 5 is moved in the main scanning direction M by a predetermined distance using the head moving unit 60. That is, the inkjet head 5 is moved to a position in which ink can be ejected onto a region (c) illustrated in FIG. 7. During a second printing operation, while the paper P₂ is fed in the forward direction by D_{f}, ink is ejected onto the region (c) corresponding to resolution of 300 dpi by the ink ejected from the inkjet head 5 so that a second image overlapping or adjacent to the first image is formed. At this time, the printing status of the one pixel area is represented by D₂ on paper P₂. By repeatedly performing the above procedure, during a third printing operation, ink is ejected onto a region (e) so that a third image is formed, and during a fourth printing operation, ink is ejected onto a region (g) of paper P₄ so that a fourth image is formed. Correspondingly, the printing status of the one pixel area is represented by D₃ on paper P₃ after the third printing operation, and D₄ on paper P₄ after the fourth printing operation. As described above, P₁, P₂, P₃, and P₄ represent the positions of the same paper P after the printing operations and D₁, D₂, D₃, and D₄ represent an area (pixel) of the paper P. That is, by overlapping or adding the first, second, third, and fourth image, an output printing image having resolution of 1200 dpi is printed on the paper while the paper P is fed three times in the reverse direction by the distance D_{b} and four times in the forward direction by the distance D_{f}, as described above. Although the printing operation is performed in the order of the region (a), the region (c), the region (e), and then the region (g) according to the method illustrated in FIGS. 6 and 7, the printing may be performed in a different order depending on how the controller 80 moves the inkjet head 5 in the main scanning direction M. For example, the printing may be performed in the order of the region (a), the region (e), the region (c), and then the region (g).

FIG. 8 illustrates the shingling printing method according to another embodiment of the present general inventive concept. Similar to FIG. 6, for illustration purposes, the positions of the paper P are disposed from up to down in FIG. 8 according to successive movements. However, as mentioned above, it should be understood that the paper positions actually overlap along the subsidiary scanning direction S (feeding direction), and that the paper P has no movement in a direction perpendicular to the subsidiary scanning direction S (i.e. the main scanning direction). According to another embodiment of the present general inventive concept, FIG. 8 illustrates a printing method in which the image is printed on the paper P three times while feeding the paper P in the forward direction and in the reverse direction, respectively, by same distance (D_{b}=D_{f}), and during a fourth printing operation, the paper P is fed in the forward direction by twice the distance (2×D_{f}) and the printing operation is repeated four more times. The image having resolution of 1200 dpi can be printed onto the paper P by repeatedly performing the above procedure. As illustrated in FIG. 8, the positions P₁, P₂ and P₃ may be the same for each of the first through the third printing operations.

The shingling printing method according to exemplary embodiments of the present general inventive concept will now be described.

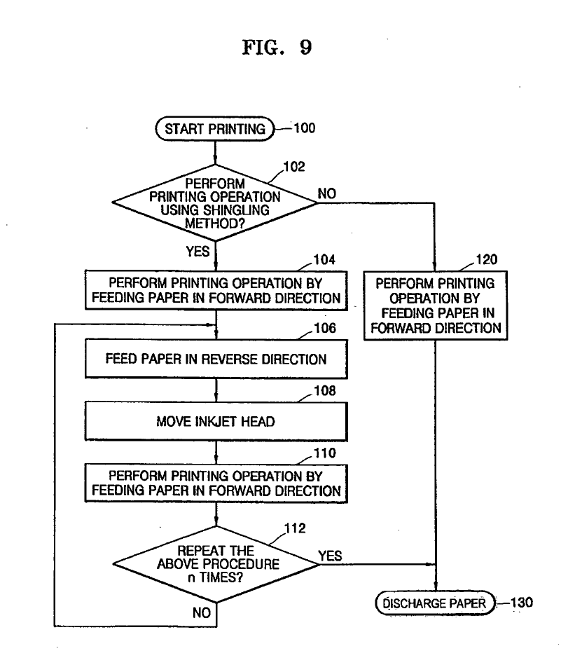

FIG. 9 is a flowchart illustrating an algorithm for printing using the shingling printing methods illustrated in FIG. 6 or 8. Referring to FIGS. 2 and 9, if a printing operation starts in operation 100, the controller 80 (see FIG. 4) controls the paper feeding unit 30 and the operation of the head moving unit 60 according to whether the printing operation is performed using the shingling printing method, in operation 102. When the printing operation is performed in a normal mode (i.e., not using the shingling printing methods), the paper P is fed in the forward direction and printed in operation 120. If the printing operation is completed, the paper P is fed by the paper discharging rollers 12 and 13 to an outside of the image forming apparatus in operation 130.

When the printing operation is performed using the shingling printing method, the paper P is fed in the forward direction by a forward moving distance and the printing operation is performed, in operation 104.

Then, the paper P is fed in a reverse direction in operation 106. When the paper P is fed in the reverse direction, a reverse feeding distance may be less than or equal to the distance D between the front-end nozzle 11C that is closest to the feeding roller 15 and the feeding roller 15. Additionally, the paper P may be fed so that the reverse feeding distance is less than or equal to the forward feeding distance.

When the paper P is fed in the reverse direction as described above, the inkjet head 5 is moved in a stepwise manner in the main scanning direction M using the head moving unit 60 in operation 108. The operation of feeding the paper P in the reverse direction (the operation 106) and the operation of moving the inkjet head 5 (the operation 108) may be performed simultaneously or successively. In this case, the inkjet head 5 may be moved stepwise in the main scanning direction M by a first distance obtained by equally dividing the physical distance ‘d’ (see FIG. 3) between nozzles or by a second distance obtained by adding a multiple of the physical distance ‘d’ between the nozzles (Nd, where N may be 1, 2, . . . ) and the first obtained by equally dividing the physical distance ‘d’. Alternatively, when the actual resolution of the nozzles is ‘l’ and the resolution at which the image is to be printed is ‘m’, the inkjet head 5 may be moved by a distance obtained by equally dividing the physical distance ‘d’ between the nozzles by m/l.

After the paper P is fed in the reverse direction as described above, the paper P is again fed in the forward direction and the printing operation is performed in operation 110. The above procedure is repeated a predetermined number of times ‘n’ by returning according to an operation 112 to the operation 106. When the printing operation is completed, the paper P is fed by the paper discharging roller 12 and 13 to the stacking unit 50 of the image forming apparatus in operation 130.

As described above, in a shingling printing method and an inkjet image forming apparatus according to various embodiments of the present general inventive concept, a high-quality image can be formed by printing using the shingling methods both in the main scanning direction and in the paper feeding direction. In addition, when printing using the shingling methods, a printing resolution of the inkjet head that has an actual resolution that is physically determined by the distance between the nozzles can be increased. In addition, even when a part of the nozzles provided in the inkjet head is damaged, the inkjet head is moved in the main scanning direction to alleviate printing defects due to the damaged part of the nozzles. In addition, the various embodiments of present general inventive concept can perform a multi-layer printing operation by printing colors with low resolution first and then by filling an image after a predetermined time has elapsed, thereby improving a printing quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A shingling method performed in an inkjet image forming apparatus including an inkjet head having nozzles arranged along a main scanning direction to print an image by ejecting ink onto a paper, a feeding roller and a paper discharging roller to feed and discharge the paper, the method comprising:
feeding the paper in a forward direction and performing a printing operation;
feeding the paper in a reverse direction;
moving the inkjet head in a main scanning direction perpendicular to the forward direction; and
repeatedly performing each of the operations of feeding the paper in the forward direction and performing a printing operation, feeding the paper in a reverse direction, and moving the inkjet head in the main scanning direction n times and performing a final printing operation.

2. The shingling method of claim 1, wherein the feeding of the paper in the reverse direction is performed so that a feeding distance in the reverse direction is less than or equal to a distance between a front-end nozzle that is closest to the feeding roller and the feeding roller.

3. The shingling method of claim 2, wherein the operations of feeding of the paper in the forward direction and feeding the paper in the reverse direction are performed so that the feeding distance in the reverse direction is less than a feeding distance in the forward direction.

4. The shingling method of claim 1, wherein the moving of the inkjet head in the main scanning direction is performed in a stepwise manner by a distance obtained by equally dividing a physical distance between the nozzles in a horizontal direction.

5. The shingling method of claim 1, wherein the moving of the inkjet head in the main scanning direction is performed in a stepwise manner by a distance obtained by adding a first distance obtained by multiplying the physical distance between the nozzles by an integral multiple to a second distance obtained by equally dividing the physical distance between the nozzles.

6. The shingling method of claim 1, wherein the moving of the inkjet head in the main scanning direction is performed in a stepwise manner by a distance obtained by equally dividing a physical distance between the nozzles in a horizontal direction with a ratio m/l, where l represents an actual resolution of the nozzle unit and m represents a resolution at which to print the image on the paper.

7. The shingling method of claim 1, wherein the nozzles are arranged along the main scanning direction in an array that is longer than a width of the paper.

8. A shingling method performed in an inkjet image forming apparatus including an inkjet head having nozzles arranged along a main scanning direction to form an image by ejecting ink onto a paper, a feeding roller and a paper discharging roller to feed and discharge the paper, the method comprising:
feeding the paper in a forward direction and performing a printing operation;
moving the inkjet head in a main scanning direction perpendicular to the forward direction;
feeding the paper in a reverse direction; and
repeatedly performing each of the operations of feeding the paper in the forward direction and performing a printing operation, moving of the inkjet head in the main scanning direction, and feeding the paper in the reverse direction n times and performing a final printing operation.

9. The shingling method of claim 8, wherein the feeding of the paper is performed so that a feeding distance in the reverse direction is less than or equal to a distance between a front-end nozzle that is closest to the feeding roller and the feeding roller.

10. The shingling method of claim 9, wherein the feeding of the paper in the forward direction and the feeding of the paper in the reverse direction are performed so that the feeding distance in the reverse direction is less than a feeding distance in the forward direction.

11. The shingling method of claim 8, wherein the moving of the inkjet head in the main scanning direction is performed in a stepwise manner by a distance obtained by equally dividing a physical distance between the nozzles in a horizontal direction.

12. The shingling method of claim 8, wherein the moving of the inkjet head in the main scanning direction is performed in a stepwise manner by a distance obtained by adding a first distance obtained by multiplying a physical distance between the nozzles by an integral multiple to a second distance obtained by equally dividing the physical distance between the nozzles.

13. The shingling method of claim 8, wherein the moving of the inkjet head in the main scanning direction is performed in a stepwise manner by a distance obtained by equally dividing a physical distance between the nozzles in the horizontal direction with a ratio m/l, where l represents an actual resolution of the nozzle unit and m represents a resolution at which to print the image on the paper.

14. The shingling method of claim 8, wherein the nozzles are arranged along the main scanning direction in an array that is longer than a width of the paper.

15. An inkjet image forming apparatus, comprising:
an inkjet head having nozzles arranged along a main scanning direction to print an image by ejecting ink onto paper and installed to make a reciprocating motion in the main scanning direction;
a paper feeding unit having a feeding roller and a paper discharging roller to feed the paper in a forward or reverse direction;
a head moving unit to move the inkjet head in the main scanning direction; and
a controller to control operations of the paper feeding unit so that the paper is moved in the forward direction during a printing operation and then the paper is moved in the reverse direction after the printing operation, and to control the head moving unit so that the inkjet head is moved in the main scanning direction when the paper is moved in the reverse direction.

16. The inkjet image forming apparatus of claim 15, wherein the controller controls the paper feeding unit to repeatedly perform the feeding of the paper in the reverse direction and in the forward direction n times and to control the inkjet head to print the image on the paper when the paper is fed in the forward direction.

17. The inkjet image forming apparatus of claim 16, wherein the controller controls the paper feeding unit to feed the paper in the reverse direction so that a feeding distance in the reverse direction is less than or equal to a distance between a front-end nozzle that is closest to the feeding roller and the feeding roller.

18. The inkjet image forming apparatus of claim 17, wherein the controller controls the paper feeding unit to feed the paper in the reverse direction so that the feeding distance in the reverse direction is less than a feeding distance in the forward direction.

19. The inkjet image forming apparatus of claim 16, wherein the controller controls the head moving unit to move the inkjet head in a stepwise manner by a distance obtained by equally dividing a physical distance between nozzles in a horizontal direction.

20. The inkjet image forming apparatus of claim 16, wherein the controller controls the head moving unit to move the inkjet head in a stepwise manner by a distance obtained by adding a first distance, which is obtained by multiplying a physical distance between the nozzles by an integral multiple, to a second distance obtained by equally dividing the physical distance between the nozzles.

21. The inkjet image forming apparatus of claim 16, wherein the controller controls the head moving unit to move the inkjet head in a stepwise manner by a distance obtained by equally dividing a physical distance between the nozzles in the horizontal direction by a ratio m/l, where l represents an actual resolution of the nozzle unit and m represents a resolution at which to print the image on the paper.

22. The inkjet image forming apparatus of claim 16, wherein the head moving unit comprises:
an adjusting portion to move the inkjet head in the main scanning direction in a stepwise manner; and
a bias portion to bias the inkjet head moved by the adjusting portion toward an original position thereof.

23. The inkjet image forming apparatus of claim 22, wherein the adjusting portion comprises:
an eccentric cam rotatably installed on a main body frame to move the inkjet head; and
a driving source to rotate the eccentric cam.

24. The inkjet image forming apparatus of claim 22, wherein the bias portion comprises:
an elastic member installed between the main body frame and the inkjet head to elastically bias the inkjet head toward an original position thereof.

25. The inkjet image forming apparatus of claim 15, wherein the nozzles are arranged in an array that is longer than a width of the paper.

26. A printing method performed in an inkjet image forming apparatus including an inkjet head having nozzles arranged along a main scanning direction corresponding to a width of a recording medium fed in a feeding direction perpendicular to the main scanning direction, the method comprising:
performing at least one cycle including moving the recording medium in a forward direction by a first distance under the inkjet head that ejects ink onto the recording medium, moving the recording medium by a second distance less than or equal to the first distance in a reverse direction, and shifting an inkjet head position in a transverse direction perpendicular to the forward direction.

27. An inkjet image forming apparatus to print an image of a recording medium that moves along a recording medium path, the apparatus comprising:
a feeding module to pickup the recording medium from a recording medium storage unit, to move the recording medium along the recording medium path and to discharge the recording medium in a stacking unit;
a printing unit disposed above the recording medium path to eject ink onto the recording medium corresponding to the image; and
a control unit to control the feeding module to move the recording medium repeatedly in a forward direction and in a reverse direction under the printing unit, and to shift a position of the printing unit in a direction perpendicular to the recording medium path when the recording medium is moved in the reverse direction.

28. The inkjet image forming apparatus of claim 27, wherein the feeding unit comprises:
a pickup roller to pickup the recording medium from the recording medium storage unit;
at least one pair of feeding rollers to guide the recording medium to move along the recording medium path; and
at least one pair of discharging rollers to discharge the recording medium in the stacking unit.

29. The inkjet image forming apparatus of claim 27, wherein the image forming apparatus is capable of printing an image on the recording medium according to a first mode when the printing unit is fixed and the recording medium passes once under the printing unit to be printed, and a second mode when the recording medium is repeatedly moved in the forward direction and in the reverse direction under the printing unit, and the position of the printing unit is shifted in the direction perpendicular to the recording medium path when the recording medium is moved in the reverse direction.

30. The inkjet image forming apparatus of claim 27, wherein the control unit controls the feeding module to move the recording medium repeatedly in the forward direction and in the reverse direction under the printing unit according to one of a first mode when a distance of moving the recording medium in the reverse direction is equal to a distance of moving the recording medium in the forward direction, and a second mode when the distance of moving the recording medium in the reverse direction is less than the distance of moving the recording medium in the forward direction.

31. The image forming apparatus of claim 27, wherein the control unit comprises:
an adjusting portion to shift the position of the printing unit in the direction perpendicular to the recording medium path stepwise; and
a bias unit to push back the printing unit when the recording medium is discarded in the stacking unit.

32. The image forming apparatus of claim 27, wherein the printing unit comprises:
a plurality of nozzles arranged in an array corresponding with a width of the recording medium to eject ink onto the recording medium when the recording medium passes along the recording medium path under the printing unit.

33. The image forming apparatus of claim 32, wherein the plurality of nozzles eject ink of a plurality of colors, and the array includes rows of nozzles from the plurality of nozzles ejecting ink of each of the plurality of ink colors disposed perpendicular to the recording medium path.

34. The image forming apparatus of claim 27, wherein the control unit comprises a user interface to enable selecting a resolution at which to print the image on the recording medium.

35. The image printing apparatus of claim 34, wherein the control unit further comprises:
a step determining unit to determine a distance to shift the position of the printing unit in the direction perpendicular to the recording medium path when the recording medium is moved in the reverse direction, wherein the distance is obtained by equally dividing a nozzle distance by a ratio of a nominal resolution of the printing unit and a target resolution to print the image on the recording medium.

36. The image printing apparatus of claim 35, wherein the step determining unit adds to the determined distance at least one nozzle distance when the determined distance is less than a predetermined minimum distance.

37. An image forming apparatus, comprising:
a wide array type inkjet head having a plurality of nozzles defining a first resolution, and the wide array type inkjet head being movable laterally;
a feeding unit to move a recording medium forward and backward with respect to the wide array type inkjet head; and
a control unit to control the wide array type inkjet head to print an image having a second resolution, which is greater than the first resolution, by moving the wide array type inkjet head laterally by a predetermined distance, and to control the feeding unit to move the recording medium forward and backward such that the wide array type inkjet head performs a predetermined number of printing operations.

38. A shingling printing method usable in an image forming apparatus, the method comprising:
performing a first printing operation on a recording medium having a length corresponding to a width of the recording medium;
moving the inkjet print head laterally with respect to the recording medium; and
performing a second print operation on the recording medium using the inkjet head.

39. The method of claim 38, wherein the performing of the second printing operation comprises:
moving the recording medium in a reverse direction with respect to the inkjet head.
